(19) United States
(12) Patent Application Publication
(10) Pub. No.: US 2017/0063557 A1
(43) Pub. Date: Mar. 2, 2017

(54) DETECTION OF FRAUDULENT CERTIFICATE AUTHORITY CERTIFICATES

(71) Applicant: FORTINET, INC., Sunnyvale, CA (US)

(72) Inventor: Michael F. Chalmandrier-Perna, Sunnyvale, CA (US)

(73) Assignee: FORTINET, INC., Sunnyvale, CA (US)

(21) Appl. No.: 14/839,346

(22) Filed: Aug. 28, 2015

(51) Int. Cl. H04L 9/32; H04L 29/06

(52) U.S. Cl. CPC H04L 9/3268; H04L 63/20; H04L 63/101

(57) ABSTRACT

Systems and methods for verifying a certificate authority are provided. According to one embodiment, a network security device intercepts a session between a client and a server, wherein a secure channel is requested to be established between the client and the server in the session. The network security device captures a digital certificate that is being sent from the server to the client, wherein the digital certificate is used for authenticating the server in connection with establishing the secure channel. The network security device verifies whether a certificate authority (CA) that signs the captured digital certificate is a trusted CA. An action is performed with respect to the session based on a result of the verifying.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright ©2015, Fortinet, Inc.

### BACKGROUND

Field

Embodiments of the present invention generally relate to computer networking. In particular, various embodiments relate to detection of un-trusted certificate authority (CA) certificates.

Description of the Related Art

Many networking applications require secure and authenticated communications. Secure Sockets Layer (SSL) and its related protocols are often used to enable secure communications between a client and a server. According to SSL protocols, session information between an SSL client and an SSL server are negotiated through a handshake phase and the identity of the SSL server is verified by the SSL client. The session information may include a session ID, peer certificates, the cipher specification to be used, the compression algorithm to be used, and shared secrets that are used to generate symmetric cryptographic keys. The SSL client encrypts a premaster secret with a public key from the SSL server's certificate and transmits the premaster secret to the server. Then, both parties compute the master secret locally and derive the session key from it. After the handshake phase, a secure socket is established, and application data encrypted by the session key can be securely transmitted between the client and server.

During the handshake phase, the SSL server sends a server certificate that is issued by a certificate authority (CA) and signed with a CA certificate. When the server certificate is received by the SSL client, the SSL client may extract the certificate path of the server certificate and locate the CA certificate. The SSL client may search for the CA certificate in its certificate store. If the CA certificate that signed the server certificate is one of the trusted root certificates that are installed in the certificate store, the SSL client trusts and accepts the server certificate. If the CA certificate is not one of the trusted root certificates, the SSL client may reject the server certificate and present a warning message to the user. The user is warned that the security certificate is not issued by a trusted CA and is provided with options to continue or stop establishing the secure connection. If the user decides to continue the secure connection even though the CA is not trusted by the SSL client, the SSL client may temporally accept this CA certificate. Generally, it is not a good practice for the user to accept un-trusted certificates when a warning message is presented.

In the above model of trust, a CA is a trusted third party to both the owner of the certificate that is issued by the CA and by the party relying upon the certificate. A web browser may include a list of trusted root certificate authorities that are trusted by the browser. Digital certificates that are signed by a CA in the list are trusted by the browser user by default. Generally, CAs that are trusted by default are those most commonly used and trusted by Internet users. However, a root CA may become unreliable. For example, a root CA may be trusted by most popular browsers by default, but unauthorized server certificates may have been issued by the root CA or an intermediate CA operating under the authority of the root CA. In such a situation, the unauthorized certificates will not be deemed as fraudulent server certificates by the browsers because they are signed by the trusted CA that is trusted by default. When this kind of breach of trust happens, it is a crisis for the whole Internet because almost every Internet user is using one or more of the popular browsers and the breached CA is trusted by nearly every user. The developer of a browser program may remove the breached CA from the trusted root certificate list and put the breached CA in a blacklist by creating and distributing a patch for the browser. However, since the browser may be installed on millions of client machines, it may take a long time for the patch to be installed on the affected client machines. In the meantime, those client machines that have not been patched remain at risk as a result of the certificates that were issued by the breached CA.

Therefore, there is a need for a mechanism for detecting and controlling untrusted CAs on behalf of client computer systems at a network level.

### SUMMARY

Systems and methods are described for verifying a certificate authority. According to one embodiment, a network security device intercepts a session between a client and a server, wherein a secure channel is requested to be established between the client and the server in the session. The network security device captures a digital certificate that is being sent from the server to the client, wherein the digital certificate is used for authenticating the server in connection with establishing the secure channel. The network security device verifies whether a certificate authority (CA) that signs the captured digital certificate is a trusted CA. An action is performed with respect to the session based on a result of the verifying.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates an exemplary network architecture in accordance with an embodiment of the present invention.

FIG. 2 illustrates exemplary functional units of a network security device in accordance with an embodiment of the present invention.

FIG. 3 is a flow diagram illustrating a method for checking a server certificate in a session between a client and a server in accordance with an embodiment of the present invention.

FIG. 4 is an exemplary computer system in which or with which embodiments of the present invention may be utilized.

### DETAILED DESCRIPTION

Systems and methods are described for verifying a certificate authority. According to one embodiment, a network security device intercepts a session between a client and a server, wherein a secure channel is requested to be established between the client and the server in the session. The network security device captures a digital certificate that is being sent from the server to the client, wherein the digital certificate is used for authenticating the server in connection with establishing the secure channel. The network security device verifies whether a certificate authority (CA) that signs the captured digital certificate is a trusted CA; and performs an action with respect to the session based on a result of the verifying.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

The phase “network security device” generally refers to a hardware or software device or appliance configured to be coupled to a network and to provide one or more of data privacy, protection, encryption and security. The network security device can be a device providing one or more of the following features: network firewalling, virtual private networking (VPN), antivirus, intrusion prevention (IPS), content filtering, data leak prevention, antispam, antispyware, logging, reputation-based protections, event correlation, network access control, vulnerability management. Load balancing and traffic shaping—that can be deployed individually as a point solution or in various combinations as a unified threat management (UTM) solution. Non-limiting examples of network security devices include proxy servers, firewalls, VPN appliances, gateways, UTM appliances and the like.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

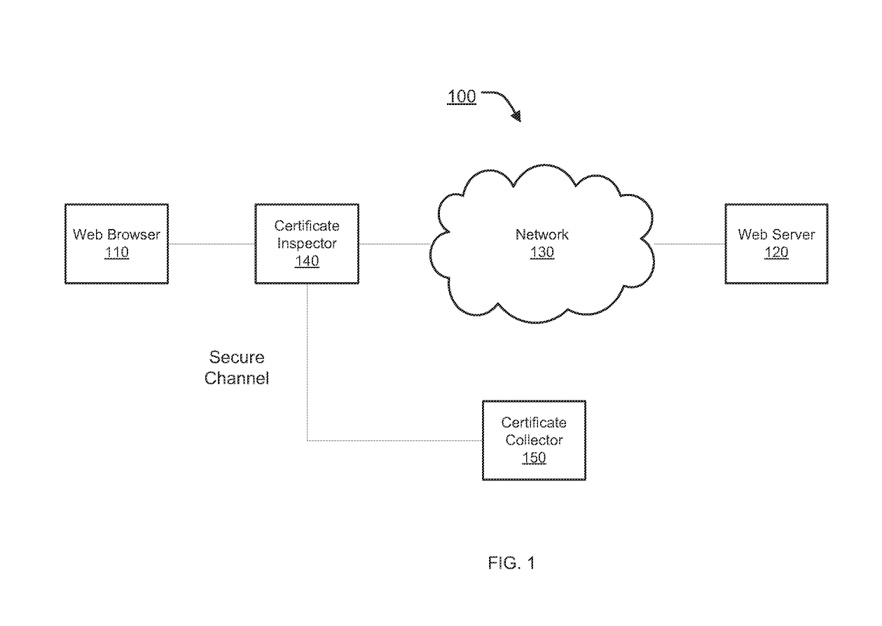

FIG. 1 illustrates an exemplary network architecture 100 in accordance with an embodiment of the present invention. Network architecture 100 includes at least one client, such as web browser 110, at least one server, such as web server 120, a network 130, a certificate inspector 140 and a certificate collector 150. In the present example, web browser 110 initiates a session to establish a secure channel with web server 120 through network 130, which may be any type of public or private network, such as a local area network (LAN), a wireless LAN, a wide area network (WAN), or the Internet. The secure channel represents a network connection in which data is encrypted when transmitted between the client and server to protect the data from being used by a third party. Depending upon the particular implementation, the encryption mechanism can be any type of encryption, including, but not limited to, Secure Sockets Layer/Transport Layer Security (SSL/TLS), and Internet Protocol security (IPsec). To establish the secure channel, a server certificate is sent from web server 120. The server certificate is signed by a CA to verify that the server is trusted and the message is actually sent from the server. Web browser 110 may check the certificate path of the server certificate to ascertain the CA certificate that signed the server certificate. If the CA certificate is in the trusted root certificate list of web browser 110, then the server certificate is deemed to be an authentic server certificate.

To protect the client, such as web browser 110 from an untrusted certificate, in the present embodiment, certificate inspector 140 is deployed between web browser 110 and web server 120. In one potential usage scenario, certificate inspector 140 may be implemented within a firewall (e.g., one of the FortiGate family of firewalls/UTM appliances manufactured by the assignee of the present invention) or other network security device that is deployed at a border of a private network (e.g., an enterprise network) to protect other network appliances and client computer systems associated with the private network. In another potential usage scenario, certificate inspector 140 may be implemented as part of an endpoint security management software application (e.g., one of the FortiClient family of endpoint protection suites manufactured by the assignee of the present invention) that is installed on client devices. Certificate inspector 140 may intercept network traffic between web browser 110 and web server 120 and control the network traffic based on security policies defined by a network administrator. According to the SSL protocol, web browser 110 sends a client hello message to web server 120 during a handshake phase. In response, web server 120 returns a server hello message with a server certificate to web browser 110. The hello messages and the server certificate are sent in plain text without encryption. Certificate inspector 140 may analyze session messages between web browser 110 and web server 120 to capture the server certificate from the server hello message sent from web server 120 to web browser 110.

Certificate inspector 140 may include a blacklist of untrusted CAs. For example, the blacklist may be a collection of CAs that are not trusted by most popular commercial browsers. Certificate inspector 140 may also include a whitelist of trusted CAs. For example, the white list may be a collection of names of well-known CAs that are trusted by most popular commercial browsers by default. The blacklist and whitelist may be collected by certificate inspector 140 or downloaded from another network security device, e.g., one offering integrated subscription based security services, such as the FortiGuard family of integrated subscription based security services available from the assignee of the present invention or one offering hosted security services, such as the FortiCloud family of hosted security analytics, log retention and management services provided by the assignee of the present invention.

After a server certificate is captured, certificate inspector 140 may extract a certificate path of the captured server certificate. The certificate path may include a root CA certificate, as well as intermediate certificates, if any. An issuer of the root CA certificate may be extracted from the root CA certificate. Certificate inspector 140 may search for the issuer in the blacklist and the whitelist. If the issuer is in the blacklist, the captured server certificate is deemed to be an untrusted server certificate. For example, if a CA that issued an unconstrained intermediate certificate to an intermediate CA is deemed as untrusted by most commercially available web browsers, an administrator of certificate inspector 140 may add the name of the CA to the blacklist. If a server certificate is signed by the CA in the blacklist, the server certificate is deemed as untrusted even it is an authentic server certificate. Similarly, if a CA is in the whitelist, then the CA is deemed as a trusted CA and the server certificate that is signed by the CA may be trusted by certificate inspector 140.

After the CA is verified as a trusted certificate authority, the server certificate may be further verified. The session messages between web browser 110 and web server 120 are allowed by certificate inspector 140 if the server certificate is deemed to be an authentic certificate. The secure channel may be established and data may be transmitted between web browser 110 and web server 120 through the secure channel.

If the CA is deemed to be an untrusted CA, certificate inspector 140 may take one or more actions with respect to network traffic between web browser 110 and web server 120 based on a security policy of the private network being protected by certificate inspector 140. For example, a warning message may be presented to the user of web browser 110 to inform the user regarding the untrusted CA. As discussed in the Background, for existing client devices, if a CA certificate of an untrusted CA is installed within the trusted root certificate list of a browser, server certificates signed by the untrusted CA are treated as authentic server certificates by web browser and no warning message is displayed to the user. In contrast, in the context of embodiments of the present invention, the server certificate signed by an untrusted CA may be identified by certificate inspector 140 and a warning message may be displayed to the user even if the root CA certificate is trusted by the browser by default. In another example, network traffic between web browser 110 and web server 120 may be blocked by certificate inspector 140 if an untrusted CA certificate is detected.

In some examples, the blacklist and/or whitelist of CAs may be collected by a certificate collector 150 (e.g., one offering integrated subscription based security services, such as the FortiGuard family of integrated subscription based security services available from the assignee of the present invention) that can be accessed by certificate inspector 140. Certificate collector 150 may maintain a whitelist of CAs by collecting root CA certificates that are installed on popular browsers by default. Certificate collector 150 may also maintain a blacklist of CAs by incorporating a CA within the blacklist if the CA is found to have issued an unconstrained certificate. Certificate collector 150 may distribute the blacklist and/or the whitelist to certificate inspector 140 through a secure channel between certificate collector 150 and certificate inspector 140 when there is an update to the blacklist and/or the whitelist. In the present example, when a CA that is trusted by most browsers becomes untrusted, it is not necessary to distribute updates to millions of browsers in order to remove the CA from the trusted root certificate authority lists of the browsers. Rather, the administrator of the certificate collector 150 may add the CA to the blacklist of CAs and the blacklist may be distributed to certificate inspectors (e.g., certificate inspector 140) that may be deployed at borders of private networks. Because each certificate inspector may be used for controlling network traffic of thousands of browsers, updating the blacklists of certificate inspectors is quicker and easier than updating browsers that are installed on millions of client machines.

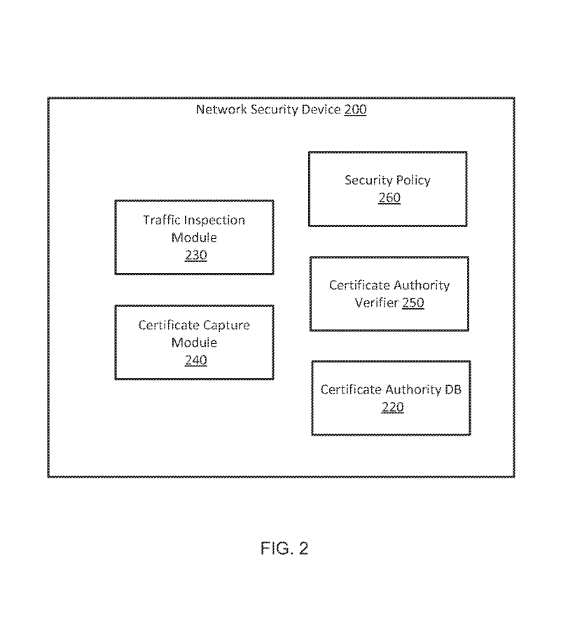

FIG. 2 illustrates exemplary functional units of a network security device 200 in accordance with an embodiment of the present invention. In this example, network security device 200 may be used as or otherwise incorporate a certificate inspector (e.g., certificate inspector 140 of FIG. 1). Network security device 200 may include a certificate authority DB 220, a traffic inspection module 230, a certificate capture module 240, a certificate authority verifier 250 and a security policy 260.

Certificate authority DB 220 is used for storing certificate authorities that issue CA certificates to Internet users, such as web servers or individual users. In some examples, the certificate authorities can be root certificate authorities. In some other examples, intermediate certificate authorities may also be included in certificate authority DB 220. A blacklist and/or a whitelist of CAs may also be included in certificate authority DB 220. The blacklist/whitelist of certificate authorities may include names of certificate authorities and/or root CA certificates that are issued by the CAs. Certificate authority DB 220 may be a local, remote or cloud-based database that can be accessed by network security device 200. In another example, certificate authority DB 220 may be downloaded from other network security devices that provide certificate authority authentication services, such as the certificate collector 150 in FIG. 1.

Traffic inspection module 230 is used for capturing network traffic of client devices that are connected to a private network that is protected by network security device 200. Network traffic going through the private network may be scanned, and then allowed, dropped or blocked based on the results of scanning.

Data packets of network traffic captured by traffic inspection module 230 may be analyzed by certificate capture module 240. Session messages between clients and servers may be detected by certificate capture module 240. When a server hello message is observed/detected, certificate capture module 240 may further capture a server certificate that is included in the hello message based on a corresponding protocol.

Certificate authority verifier 250 is used for verifying whether a certificate authority that signed the captured server certificate is a trusted certificate authority. For example, certificate authority verifier 250 may extract a certificate path of the captured server certificate including the root CA certificates and intermediate certificates, if any. In one example, certificate authority verifier 250 may check the issuer names of the root CA certificates and intermediate certificates in certificate authority DB 220 and determine whether the issuers are trusted CAs. If the root CA or the intermediate CA is in the blacklist of certificate authorities, the captured server certificate is deemed to be an untrusted server certificate. Similarly, if the root CA or the intermediate CA is in the whitelist of certificate authorities, the captured server certificate is deemed to be a trusted server certificate or further verified by other certificate verification mechanism. In another example, certificate authority verifier 250 may check the root CA certificate and intermediate certificates in certificate authority DB 220 and determine whether the root CA certificate and the intermediate CA certificates are trusted. If the root CA certificate or the intermediate CA certificates are in the blacklist of certificate authorities, the captured server certificate is deemed to be an untrusted server certificate. Similarly, if the root CA certificate or the intermediate CA certificates are in the whitelist of certificate authorities, the captured server certificate is deemed to be a trusted server certificate or further verified by other certificate verification mechanism.

After certificate authority verifier 250 determines whether the captured server certificate is an authentic server certificate, traffic inspection module 230 may take one or more actions on the session between the client and the server in accordance with security policy 260 that is defined by the administrator of network security device 200. For example, when the root CA and intermediate CAs of the captured server certificate are confirmed, traffic inspection module 230 may allow the network traffic. Then, the server hello message as well as the server certificate may be routed to the client and a secure channel between the client and the server may be established based on a key exchange protocol. When, however, any of the root CA and the intermediate CAs of the captured server certificate are deemed to be untrusted CA, traffic inspection module 230 may cause a warning message to be presented on the client device. The warning message may include information regarding the untrusted CA and the captured server certificate. The warning message may provide the user of the client device with an option to block the session or allow the session to be continued with the suspicious server certificate. Alternatively, traffic inspection module 230 may drop or block the session between the client and the server directly, without seeking input from the user of the client device.

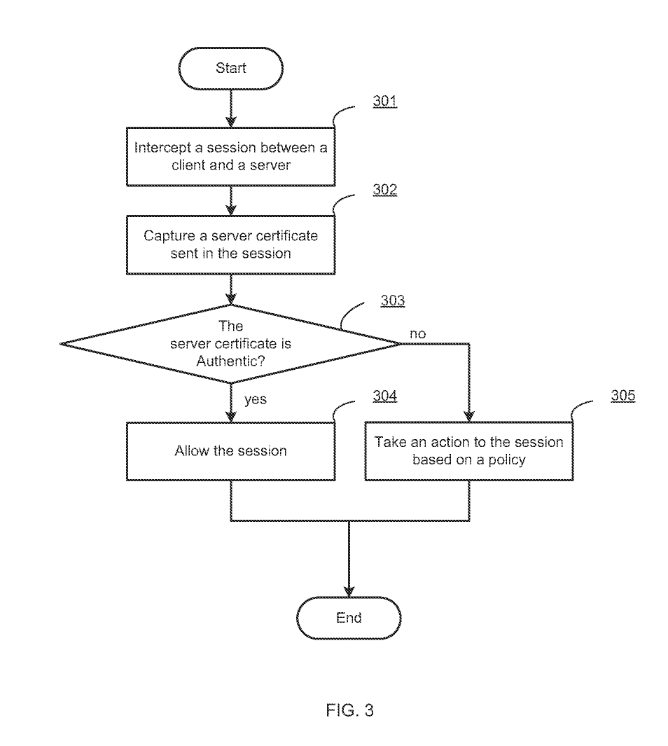

FIG. 3 is a flow diagram illustrating a method for checking a server certificate in a session between a client and a server in accordance with an embodiment of the present invention. This method may be implemented by a network security device (e.g., network security device 200 or another network security device or appliance representing or implementing certificate inspector 140).

At block 301, a network security device intercepts a session between an SSL client and an SSL server. The network security device may be deployed at the border of a private network and may be used for controlling network traffic within the private network and/or network traffic entering or exiting the private network. The data packets going through the private network may be scanned by the network security device and session messages may be intercepted by the network security device.

At block 302, the network security device captures a server certificate that is included in a session message, e.g., a server hello message, that is used for establishing a secure channel between the SSL client and the SSL server. According to the SSL protocol, session information between the SSL client and the SSL server is negotiated through a handshake phase and the server certificate that is the identity of the SSL server is sent to the SSL client in plain text. The network security device may capture the server certificate from the session message. A certificate path, including a root CA and any intermediate CAs, may be extracted from the captured server certificate. The issuers' names of the root CA and the intermediate CAs may be extracted from the root CA certificate and the intermediate CAs.

At block 303, network security device verifies whether a CA that signed the captured server certificate is a trusted CA before the session is routed to the SSL client. The verification of a CA may be include consultation of a blacklist and/or a whitelist of CAs.

At block 304, the network security device may allow the session and route it to the SSL client when the captured server certificate is signed by a trusted CA. Then, the SSL client and the SSL server may communicate as normal and a secure channel may be established.

At block 305, the network security device may take one or more actions with respect to the session between the SSL client and SSL server based on a security policy if the root CA or the intermediate CA of the captured server certificate is deemed to be untrusted. For example, if the root CA is in the blacklist, then the captured server certificate may be deemed to be an untrusted server certificate and the session between the SSL client and the SSL server may be blocked by the network security device and no secure channel may be established. In some embodiments, when the captured server certificate is signed by an unknown CA to the network security device, a warning message may be sent to the user of the SSL client to allow the user an opportunity to determine whether the unknown CA should be accepted.

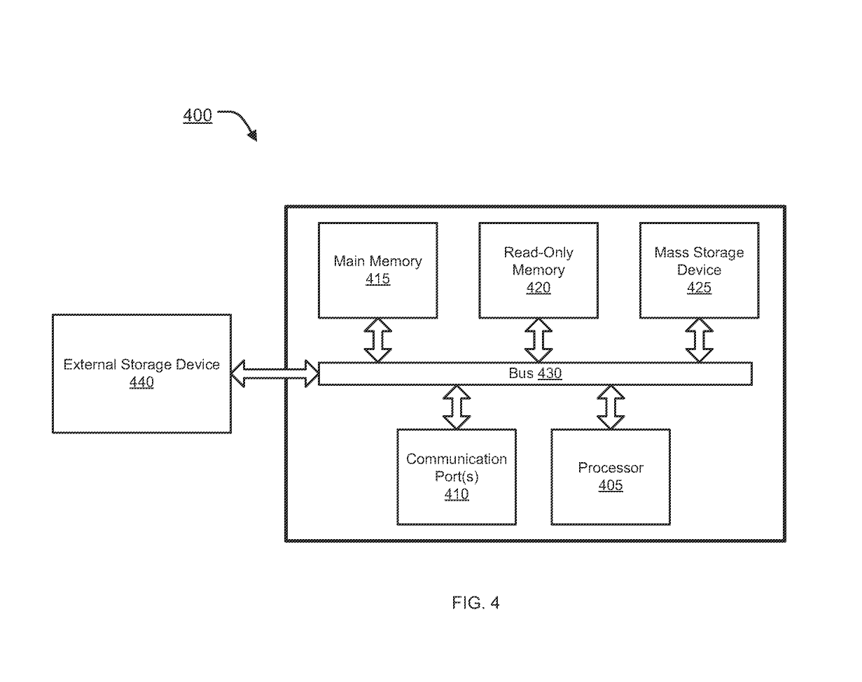

FIG. 4 is an example of a computer system 400 with which embodiments of the present disclosure may be utilized. Computer system 400 may represent or form a part of a network security device (e.g., network security device 200), a server or a client workstation on which web browser 110 and/or certificate inspector 140 is running

Embodiments of the present disclosure include various steps, which have been described in detail above. A variety of these steps may be performed by hardware components or may be embodied on a non-transitory computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 400 includes a bus 430, a processor 405, communication port 410, a main memory 415, a removable storage media 440, a read only memory 420 and a mass storage 425. A person skilled in the art will appreciate that computer system 400 may include more than one processor and communication ports.

Examples of processor 405 include, but are not limited to, an Intel® Itanium® or Itanium 2 processor(s), or AMDC® Opteron® or Athlon MP® processor(s), Motorola® lines of processors, FortiSOC™ system on a chip processors or other future processors. Processor 405 may include various modules associated with embodiments of the present invention.

Communication port 410 can be any of an RS-232 port for use with a modem based dialup connection, a 10/100 Ethernet port, a Gigabit or 10 Gigabit port using copper or fiber, a serial port, a parallel port, or other existing or future ports. Communication port 410 may be chosen depending on a network, such a Local Area Network (LAN), Wide Area Network (WAN), or any network to which computer system 400 connects.

Memory 415 can be Random Access Memory (RAM), or any other dynamic storage device commonly known in the art. Read only memory 420 can be any static storage device(s) such as, but not limited to, a Programmable Read Only Memory (PROM) chips for storing static information such as start-up or BIOS instructions for processor 405.

Mass storage 425 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 430 communicatively couples processor(s) 405 with the other memory, storage and communication blocks. Bus 430 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 405 to system memory.

Optionally, operator and administrative interfaces, such as a display, keyboard, and a cursor control device, may also be coupled to bus 430 to support direct operator interaction with computer system 400. Other operator and administrative interfaces can be provided through network connections connected through communication port 410.

Removable storage media 440 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
intercepting, by a network security device protecting a private network, a session between a client associated with the private network and a remote server residing outside of the private network, wherein a secure channel is requested to be established between the client and the remote server in the session;
capturing, by the network security device, a digital certificate transmitted within the session from the remote server to the client, wherein the digital certificate is used for authenticating the remote server in connection with establishing the secure channel;
verifying, by the network security device, whether a certificate authority (CA) that signed the captured digital certificate is a trusted CA; and
performing, by the network security device, an action with respect to the session based on a result of the verifying.

2. The method of claim 1, wherein said capturing, by the network security device, a digital certificate transmitted within the session from the remote server to the client further comprises:
capturing, by the network security device, a hello message transmitted by the remote server to the client during a handshake phase of the session;
intercepting, by the network security device, the digital certificate included in the hello message.

3. The method of claim 1, further comprising:
receiving, by the network security device, a blacklist of untrusted CAs;
receiving, by the network security device, a whitelist of trusted CAs; and
storing, by the network security device, the blacklist and whitelist of CAs within a storage device that is accessible to the network security device.

4. The method of claim 3, wherein the blacklist and whitelist of CAs are manually inputted to the network security device.

5. The method of claim 3, wherein the blacklist and whitelist of CAs are downloaded from a network security device that collects trusted CAs and untrusted CAs.

6. The method of claim 3, wherein said verifying, by the network security device, whether a certificate authority (CA) that signed the captured digital certificate is a trusted CA further comprises:
determining, by the network security device, whether the CA that signed the captured digital certificate is within one of the blacklist and the whitelist of CAs;
confirming, by the network security device, the captured digital certificate when the CA that signed the digital certificate is determined to be in the whitelist; and
rejecting, by the network security device, the captured digital certificate when the CA that signed the digital certificate is in the blacklist.

7. The method of claim 1, further comprising extracting, by the network security device, a certificate path from the captured digital certificate.

8. The method of claim 7, wherein the certificate path comprises a root CA certificate and one or more intermediate certificates.

9. The method of claim 7, further comprising extracting, by the network security device, information regarding issuers of the root CA and the one or more intermediate certificates.

10. The method of claim 1, wherein the action comprises one or more of:
allowing, by the network security device, the session between the client and the remote server;
informing, by the network security device, a user of the client that the captured digital certificate of the remote server is not authentic; and
blocking, by the network security device, the session between the client and the remote server.

11. A computer system comprising:
non-transitory storage device having embodied therein instructions representing a security application; and
one or more processors coupled to the non-transitory storage device and operable to execute the security application to perform a method comprising:
intercepting a session between a client associated within a private network and a remote server residing outside of the private network, wherein a secure channel is requested to be established between the client and the remote server in the session;
capturing a digital certificate transmitted within the session from the remote server to the client, wherein the digital certificate is used for authenticating the remote server in connection with establishing the secure channel;
verifying whether a certificate authority (CA) that signed the captured digital certificate is a trusted CA; and
performing an action with respect to the session based on a result of the verifying.

12. The computer system of claim 11, wherein said capturing a digital certificate transmitted within the session from the remote server to the client further comprises:
capturing a hello message transmitted by the remote server to the client during a handshake phase of the session;
intercepting the digital certificate included in the hello message.

13. The computer system of claim 11, wherein the method further comprises:
receiving a blacklist of untrusted CAs;
receiving a whitelist of trusted CAs; and
storing the blacklist and whitelist of CAs within a storage device that is accessible to the computer system.

14. The computer system of claim 13, wherein the blacklist and whitelist of CAs are manually inputted to the computer system.

15. The computer system of claim 13, wherein the blacklist and whitelist of CAs are downloaded from a network security device that collects trusted CAs and untrusted CAs.

16. The computer system of claim 13, wherein said verifying whether a certificate authority (CA) that signed the captured digital certificate is a trusted CA further comprises:
determining whether the CA that signed the captured digital certificate is within one of the blacklist and the whitelist of CAs;
confirming the captured digital certificate when the CA that signed the digital certificate is determined to be in the whitelist; and
rejecting the captured digital certificate when the CA that signed the digital certificate is in the blacklist.

17. The computer system of claim 11, wherein the method further comprises extracting a certificate path from the captured digital certificate.

18. The computer system of claim 17, wherein the certificate path comprises a root CA certificate and one or more intermediate certificates.

19. The computer system of claim 17, wherein the method further comprises extracting information regarding issuers of the root CA and the one or more intermediate certificates.

20. The computer system of claim 11, wherein the action comprises one or more of:
allowing the session between the client and the remote server;
informing a user of the client that the captured digital certificate of the remote server is not authentic; and
blocking the session between the client and the remote server.
